(19) United States
(12) Patent Application Publication
(10) Pub. No.: US 2008/0257216 A1
(43) Pub. Date: Oct. 23, 2008

(54) NEW URETHANE (METH)ACRYLATES AND THEIR USE IN CURABLE COATING COMPOSITIONS

(75) Inventor: Jean-Pierre Ravyst, Singapore (SG)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/737,843

(22) Filed: Apr. 20, 2007

(51) Int. Cl. C08G 63/127

(52) U.S. Cl. 106/287.26; 528/288

(57) ABSTRACT

The present invention relates to new urethane (meth)acrylates, their methods of preparation and coating compositions comprising said urethane (meth)acrylates.

### FIELD OF THE INVENTION

The present invention relates to new urethane (meth)acrylates, their methods of preparation and coating compositions comprising said urethane (meth)acrylates.

### BACKGROUND OF THE INVENTION

Urethane (meth)acrylates are generally known in the art, as are methods of producing the urethane (meth)acrylates. The urethane (meth)acrylate is the reaction product of an isocyanate component and a functionalized (meth)acrylate component that is reactive with the isocyanate component. Urethane (meth)acrylates can be used in a variety of products, including structural composites and coating compositions.

Various urethane (meth)acrylates and their uses are described in WO-A-2005/105857; US-A-2005/023991; U.S. Pat. No. 4,255,243; U.S. Pat. No. 4,097,439; U.S. Pat. No. 4,855,384 (sulfonated compounds); and U.S. Pat. No. 3,719,638.

The use of certain urethane acrylates, i.e. the low molecular weight hexafunctional urethane acrylates which are the reaction products of pentaerythritol triacrylate and toluene diisocyanate or isophorone diisocyanate, in curable coating compositions is known to the person skilled in the art. However, the cured coatings obtained from those compositions are brittle.

JP-A-5-148332 discloses a curable resin composition containing as essential component a polyether urethane (meth)acrylate having three or more (meth)acrylate groups. The polyether urethane (meth)acrylate is prepared by a method wherein a polyalkylene alcohol comprising at least three hydroxyl groups is used as essential component. In all the examples a combination of 2-hydroxyethyl methacrylate and pentaerythritol triacrylate is used to introduce the (meth)acrylate groups.

It is an object of the present invention to provide new urethane (meth)acrylates that may be used in a curable coating composition resulting in hard cured coatings exhibiting high scratch and abrasion resistance as well as high chemical resistance and toughness.

### SUMMARY OF THE INVENTION

The object is met by a urethane (meth)acrylate represented by the general formula (I)

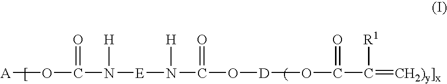

wherein
A is the residue of a polyhydric polymeric alcohol A(OH)ₓ being selected from polyether polyols, polyester polyols, polyacrylic polyols, polycaprolactone polyols, polycarbonate polyols, polyurethane polyols, and polyamide polyols;
x is 2, 3 or 4;
E is the residue of a diisocyanate OCN-E-NCO;
D is the residue of a polyhydric monomeric alcohol D(OH)_{y+1};
y is 2 to 5;
R¹ is H or methyl;
E, D, R¹, y, and x are identical or different within each molecule of the urethane (meth)acrylate;
and x and y are selected that the total number of (meth)acrylate groups —O—CO—CR¹═CH₂ is from 5 to 15.

The present invention also relates to a curable coating composition comprising said urethane (meth)acrylate as well as to a cured coating obtained from said coating composition.

Further, the present invention is directed to first method for preparing said urethane (meth)acrylate comprising the following steps:
(a1) reacting a polyhydric polymeric alcohol A(OH)ₓ being selected from polyether polyols, polyester polyols, polyacrylic polyols, polycaprolactone polyols, polycarbonate polyols, polyurethane polyols, and polyamide polyols; with a diisocyanate OCN-E-NCO or a mixture of diisocyanates OCN-E-NCO of to form an isocyanate-functional product according to formula (II)

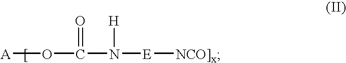

and
(b1) reacting the isocyanate-functional product (II) of step (a1) with a hydroxyl-functional poly(meth)acrylated compound according to formula (III)

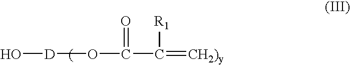

or a mixture of said hydroxyl-functional poly(meth)acrylated compounds (III) in the presence of a catalyst for urethane formation and a polymerization inhibitor to form the urethane (meth)acrylate according to formula (III),
wherein A, E, D, R¹, y, and x are defined as above.

Moreover, the present invention is directed to second method for preparing said urethane (meth)acrylate comprising the following steps:
(a2) reacting a hydroxyl-functional poly(meth)acrylated compound according to formula (III)

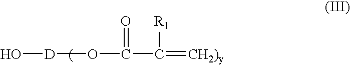

or a mixture of hydroxyl-functional poly(meth)acrylated compounds (III) with a diisocyanate OCN-E-NCO in the presence of a polymerization inhibitor to form an isocyanate-functional poly(meth)acrylated product according to formula (IV)

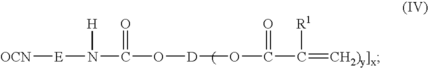

or a mixture of said isocyanate-functional poly(meth)acrylated products (IV) and
(b2) reacting the isocyanate-functional poly(meth)acrylated product (IV) of step (a2) or the mixture of said isocyanate-functional poly(meth)acrylated products (IV) with a polyhydric polymeric alcohol A(OH)ₓ being selected from polyether polyols, polyester polyols, polyacrylic polyols, polycaprolactone polyols, polycarbonate polyols, polycarbonate polyols, polyurethane polyols, and polyamide polyols, in the presence of a catalyst for urethane formation and a polymerization inhibitor to form the urethane (meth)acrylate according to formula (III), wherein A, E, D, R¹, y, and x are defined as above.

### DETAILED DESCRIPTION OF THE INVENTION

Within this application the terms “polyhydric alcohol” and “polyol” are interchangeable, that is the term “polyol” where used means “polyhydric alcohol”.

The urethane (meth)acrylate according to the present invention comprises a total number of 5 to 15, i.e. 5, 6, 7, 8, 9, 10, 11, 12, 13, 14, or 15 (meth)acrylate groups. A urethane (meth)acrylate comprising at least 5 (meth)acrylate groups and having a structure according to formula (I) wherein each terminal of the molecular structure carries at least two (meth)acrylate groups is not known from the prior art. It was in fact surprising that the coating compositions comprising the new urethane (meth)acrylates result in cured coatings having superior properties.

According to a preferred embodiment, the urethane (meth)acrylate comprises a total number of 5 to 9, i.e. 5, 6, 7, 8, or 9 (meth)acrylate groups. Cured coatings prepared from coating compositions comprising a urethane (meth)acrylate according to this embodiment are particularly tough and flexible.

A(OH)ₓ wherein x is 2, 3 or 4 can be a polyether polyol, polyester polyol, polyacrylic polyol, polycaprolactone polyol, polycarbonate polyol, polyurethane polyol, or a polyamide polyol. In some cases, x is 2 or 3, such as 2. In some cases, A(OH)ₓ does not include any sulfonated compounds.

Suitable polyether polyols include but are not limited to polyoxy-C₂-C₆-alkylene polyols, including branched and unbranched alkylene groups. e.g. products obtained by the polymerization of a cyclic oxide including ethylene oxide, propylene oxide or tetrahydrofuran, or mixtures thereof; and reaction products of alkylene oxides with polyhydric alcohols. Examples of suitable polyether diols A(OH)₂ are polyoxypropylene (PPO) glycols (poly(1,2- and 1,3-propyleneoxide)), polyoxyethylene (PEO) glycols (polyethylene oxide), poly(oxyethylene-co-oxypropylene) glycols (random or block copolymers of ethylene oxide and 1,2-propylene oxide), polyoxytetramethylene (PTMO) glycols, and poly(1,2-butyleneoxide). Examples of suitable polyether triols A(OH)₃ are the adducts of an alcohol having three hydroxyl groups (e.g. glycerol or trimethylol propane) and an alkylene oxide (e.g. ethylene oxide, propylene oxide, tetrahydrofuran, and a combination of ethylene oxide/propylene oxide). The polyether polyol often has a weight average molecular weight (“Mw” as measured by gel permeation chromatography) of from 400 to 2,000, such as from 700 to 2,000.

Suitable polyester polyols can be prepared by esterification of an organic polycarboxylic acid or anhydride thereof with an organic polyol. The organic polycarboxylic acid is reacted with the polyol so that the OH/COOH equivalent ratio is greater than 1:1 so that the resultant product contains free hydroxyl groups. The polyester diols A(OH)₂ are typically formed from diacids, or their monoester, diester, or anhydride counterparts, and diols. The polyester triols A(OH)₃ are typically formed from adequate mixtures of components selected from diacids (or their monoester, diester, or anhydride counterparts), triacids (or their monoester, diester or triester counterparts), diols, and triols. The diacids may be, for example, C₂-C₁₈, such as C₄-C₁₂ aliphatic acids, including saturated aliphatic acids, including branched, unbranched, or cyclic materials, or C₄-C₁₈, such as C₈-C₁₅ aromatic acids. Examples of suitable aliphatic acids and other non-aromatic acids are maleic, succinic, glutaric, adipic, pimelic, suberic, azelaic, sebacic, 1,12-dodecanedioic, 2-methylpentanedioic, 1,4-cyclohexanedicarboxylic, tetrahydrophthalic, hexahydrophthalic, methylhexahydrophthalic, and chlorendic acid. Examples of suitable aromatic acids are terephthalic, isophthalic, phthalic, tetrachlorophthalic, 4,4′-benzophenone dicarboxylic, 4,4′-diphenylamine dicarboxylic acid, and mixtures thereof. Examples of triacids are higher polycarboxylic acids such as trimellitic acid and tricarballylic acid.

The diols may be, for example, C₂-C₁₂ branched, unbranched, or cyclic aliphatic diols and other glycols, such as hydrogenated bisphenol A, the reaction products of lactones and diols, for example, the reaction product of ε-caprolactone and ethylene glycol, hydroxy-alkylated bisphenols, polyether glycols, for example, poly(oxytetramethylene)glycol, and the like. Examples of suitable diols are ethylene glycol, 1,3-propylene glycol, 1,2-propylene glycol, 1,2-butanediol, 1,3-butanediol, 1,4-butanediol, neopentyl glycol, 1,2-pentanediol, 1,4-pentanediol, hexanediols (e.g. 1,2-hexanediol, 1,5-hexanediol), 2-methyl-2,4-pentanediol, 2,2,4-trimethyl-1,3-pentanediol, cyclohexane-1,4-dimethanol, 3,3-dimethyl-1,2-butanediol, 2-ethyl-1,3-hexanediol, 1,12-dodecanediol, diethylene glycol, dipropylene glycol, and mixtures thereof. Examples for a suitable triols are trimethylolpropane and glycerol, as well as alkoxylated derivatives of triols such as oxyethylated or oxypropylated trimethylolpropane and glycerol.

Suitable polyester diols A(OH)₂ are, for example, made from reaction of adipic acid and ethylene glycol or a polyether polyol such as polypropylene glycol having a M_{w} of about 700.

Suitable polyacrylic polyols are for example based on homopolymers or copolymers generated from acrylic monomers such as methyl(meth)acrylate, ethyl(meth)acrylate, butyl(meth)acrylate, and ethyl-hexyl(meth)acrylate and are capped with hydroxylated monomers such as 2-hydroxylethyl(meth)acrylate, hydroxybutyl(meth)acrylate, and trimethylolpropane monoacrylate. It is sometimes advisable that the Tg exceeds 30° C. The amount of hydroxylated monomers determines the OH functionality of the polyacrylic polyol.

Suitable polycaprolactone polyols are the reaction product of ε-caprolactone and a polyol such as ethylene glycol, diethylene glycol, 1,6-hexane diol, neopentyl glycol, and trimethylolpropane.

Polycarbonate polyols formally are polyesters of carbonic acid and a diol. An example of a suitable polycarbonate is the polyester of carbonic acid and 1,6-hexane diol, commercially available as Desmophen® 2020 from Bayer MaterialScience AG, Germany.

Suitable polyurethane polyols can be formed from reacting an organic polyisocyanate with a low molecular or oligomeric polyol. The organic polyisocyanate is reacted with the polyol so that the OH/NCO equivalent ratio is greater than 1:1 so that the resultant product contains free hydroxyl groups. For example, polyurethane diols A(OH)₂ are prepared from reaction of a diisocyanate with a diol. Polyurethane triols A(OH)₃ may be prepared from adequate mixtures of components selected from triisocyanates, diisocyanates, diols and triols. For example, in case a triisocyanate and a diol are used the molar ratio of triisocyanate to diol should be about 1:3 in order to avoid too much branching and the formation of high molecular weight polyols.

An example of a suitable low molecular diol is ethylene glycol.

Examples of suitable low molecular triols and quadrols are glycerol, alkoxylated glycerol, trimethylolpropane, alkoxylated trimethylolpropane, di-trimethylolpropane.

Examples of oligomeric polyols include all the polyols mentioned above, i.e. the polyether polyols, polyester polyols, polyacrylic polyols, polycaprolactone polyols, and polycarbonate polyols, provided their molecular weight is not too high. Preferably, their weight average molecular weight is less than 200. The preferred oligomeric polyols are polyether polyols, such as polyethylene and polypropylene glycols, and polyester polyols.

Suitable polyamide polyols are hydroxyfunctional polymeric amides resulting from the condensation reaction of diamines with diacids as is conventionally known. In order to provide the essential hydroxyl functionality in the aforementioned polyamides the polyamides are reacted with either hydroxy-containing acids or hydroxy-containing amines, depending on whether an excess of amine or acid monomer is used in making the polyamide. Preferred polyamides are often those made from reacting saturated polycarboxylic acids with diamines. Examples of useful saturated polycarboxylic acids are oxalic acid, malonic acid, succinic acid, methylsuccinic acid, 2,2-dimethylsuccinic acid, 2,3-dimethylsuccinic acid, hexylsuccinic acid, glutaric acid, 2-methylglutaric acid, 3-methylglutaric acid, 2,2-dimethyglutaric acid, 3,3-dimethylglutaric acid, 3,3-diethylglutaric acid, adipic acid, pimelic acid, suberic acid, azelaic acid, sebaccic acid, phthalic acid, isophthalic acid, terephthalic acid, tetrachlorophthalic acid, 1,2-hexahydrophthalic acid, 1,3-hexahydrophthalic acid, 1,4-hexahydrophthalic acid, 1,1-cyclobutanedicarboxylic acid, and trans-1,4-cyclohexanedicarboxylic acid. Examples of diamines include 1,4-diaminobutane, 1,2-diaminocyclohexane, 1,10-diaminodecane, 1,12-diaminododecane, 1,6-diaminohexane, 1,5-diaminopentane, 1,8-diaminooctane, 1,2-diamino-2-methylpropane, 1,2-diaminopropane, 1,3-diaminopropane, 1,7-diaminoheptane, and piperazine.

Examples of hydroxy-acids for reaction with the polyamides include lactic acid, glycolic acid, hydroxy butyric acid, hydroxy stearic acid, and recinoleic acid. Suitable hydroxy-containing amines for reaction with the polyamides are aminoalcohols, such as 2-aminoethanol, 2-amino-1-butanol, 4-amino-1-butanol, 2-(2-aminoethylamino)-ethanol, 2-amino-2-ethyl-1,3-propanediol, 6-amino-1-hexanol, 2-amino-2-(hydroxymethyl)-1,3-propanediol, 2-amino-3-methyl-1-butanol, 3-amino-3-methyl-1-butanol, 2-amino-4-methyl-1-pentanol, 2-amino-2-methyl-1,3-propanediol, 2-amino-2-methyl-1-propanol, 5-amino-1-pentanol, 3-amino-1,2-propanediol, 1-amino-2-propanol, 3-amino-1-propanol, and 2-(3-aminopropylamino)-ethanol. Preferred polyamide polyols include polyester amide prepared from ethylene glycol, ethanolamine and adipic acid, and polyester amide prepared from ethylene glycol, ethanolamine and azelaic acid.

Other preferred classes of polyamide polyols include polyols derived from carboxyl or amine terminated polyamide in which the terminal carboxyl or amine groups are reacted with an alkylene oxide such as ethylene oxide or propylene oxide. Especially preferred of these is poly(hexamethylene adipamide).

Another preferred class of polyamide polyols may be prepared from the condensation reaction of a polyamine and a polycaprolactone polyol. Suitable polyamines include the diamines set forth above. Exemplary polycaprolactone polyols are those sold by Union Carbide Corp. under the trade designation “PCP 0200”.

The organic polyisocyanate which can be used in preparing the polyurethane polyols can be an aliphatic or aromatic polyisocyanate or a mixture. Examples of suitable diisocyanates include all the diisocyanates mentioned below; especially preferred are 4,4′-diphenylmethane diisocyanate, 1,4-tetramethylene diisocyanate, isophorone diisocyanate and 4,4′-methylenebis(cyclohexyl isocyanate). An example of a triisocyanate is triphenylmethane triisocyanate.

Typically, the weight average molecular weight of the polymeric polyol A(OH)ₓ is within the range of from 400 to 3,000, often from 700 to 3,000, such as from 700 to 2,500 and in some cases, from 700 to 2,000.

The preferred polymeric polyols A(OH)ₓ are often polyether polyols, such as polyether diols, and polyester polyols.

The diisocyanate OCN-E-NCO can be a monomeric or oligomeric diisocyanate. Also a mixture of different diisocyanates may be used for the preparation of the urethane (meth)acrylate according to the present invention resulting in a “unsymmetrical” urethane (meth)acrylate. Suitable diisocyanates which may be used include aromatic, aliphatic, and cycloaliphatic polyisocyanates, and combinations thereof.

Examples of suitable aliphatic and cycloaliphatic polyisocyanates are ethylene diisocyanate, 1,4-tetramethylene diisocyanate,1,6-hexamethylene diisocyanate (HMDI), cyclohexane 1,4-diisocyanate, hexahydrotoluene diisocyanate, 1,12-dodecane diisocyanate, cyclobutane-1,3-diisocyanate, 1-isocyanato-3,3,5-trimethyl-5-isocyanato methyl cyclohexane, bis(4-isocyanato cyclohexyl)methane, isophorone diisocyanate (IPDI), 4,4′-methylene bis(cyclohexyl isocyanate) (H₁₂ MDI), 1,6-diisocyanato-2,2,4,4-tetramethylhexane, and 1,6-diisocyanato-2,4,4-trimethylhexane.

Examples of suitable aromatic diisocyanates are m-phenylene diisocyanate, xylylene diisocyanate (XDI), 2,4- and 2,6-toluene diisocyanate (TDI), 1,5-naphthalene diisocyanate (NDI), 1-methoxy-2,4-phenylene diisocyanate, 4,4′-diphenylmethane diisocyanate (MDI), 2,4′-diphenylmethane diisocyanate, 4,4′-biphenylene diisocyanate, 3,3′-dimethoxy-4,4′-biphenyl diisocyanate, 3,3′-dimethyl-4,4′-biphenyl diisocyanate, 3,3′-dimethyl-4,4′-diphenylmethane diisocyanate, and 4,4′,4″-triphenylmethane diisocyanate. TDI and IPDI are sometimes preferred.

Diisocyanates being reaction products of the above diisocyanates can also be used. These reaction products include diisocyanates comprising isocyanurate, urea, allophanate, biuret, carbodiimide, or uretonimine entities.

Examples of commercially available polyisocyanates include Desmodur® H from Bayer MaterialScience AG, Germany, which is described as HDI having an NCO content of 50%, and Desmodur® W which is described as bis(4-isocyanatocyclohexyl)methane containing 32% of NCO.

Suitable monomeric polyols D(OH)_{y+1} wherein y is 2 to 5, such as 2 or 3, are any low molecular alcohols carrying 3, 4, 5, or 6, such as 4 or 5 hydroxyl groups. As indicated by the term “monomeric”, the polyols D(OH)_{y+1} do not include the polymeric polyols A(OH)ₓ mentioned above. Often the monomeric polyol D(OH)_{y+1} has a molecular weight of less than 500, such as less than 200, and in some cases, less than 140. Examples of suitable polyols D(OH)_{y+1} are glycerol, trimethylolpropane, pentaerythritol, di-trimethylolpropane, di-pentaerythritol, and alkoxylated derivatives of said polyols. Also included are alcohols comprising an amide group within their molecule which are prepared by reacting a hydroxy carboxylic acid or a lactone with an aminoalcohol comprising at least two hydroxyl groups, e.g. the reaction product of γ-butyrolactone and diethanolamine. Pentaerythritol is sometimes preferred.

In some cases, the weight average molecular weight of the urethane (meth)acrylate according to the present invention is within the range of from 1,000 to 4,000, such as from 1,200 to 3,500, or, in some cases, from 1,200 to 3,000, such as from 1,200 to 2,500.

The urethane (meth)acrylates according to the present invention can be prepared by at least two different methods.

According to the first alternative, in step (a1) the polymeric polyol A(OH)ₓ is first reacted with the diisocyanate OCN-E-NCO or a mixture of diisocyanates OCN-E-NCO to form an isocyanate-functional product according to formula (II)

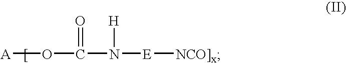

and then in step (b1) the isocyanate-functional product (II) of step (a1) is reacted with a hydroxyl-functional poly(meth)acrylated compound according to formula (III)

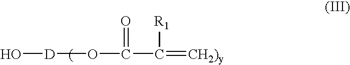

or a mixture of said hydroxyl-functional poly(meth)acrylated compounds (III) in the presence of a catalyst for urethane formation and a polymerization inhibitor to form the urethane (meth)acrylate according to formula (III).

The hydroxyl-functional poly(meth)acrylated compound (III) is a (meth)acrylic ester and the reaction product of the monomeric polyol D(OH)_{y+1} and y equivalents of methacrylic (R¹ is methyl) or acrylic (R¹ is H) acid or a corresponding ester derivative. Examples of suitable hydroxyl-functional poly(meth)acrylated compounds are trimethylpropane di(meth)acrylate, pentaerythritol tri(meth)acrylate, di-trimethylolpropane tri(meth)acrylate, and di-pentaerythritol penta(meth)acrylate.

In case a urethane (meth)acrylate (I) wherein y is not an integral multiple of x should be obtained a mixture of hydroxyl-functional poly(meth)acrylated compounds is used in step (b1). For example, a mixture of a hydroxyl-functional poly(meth)acrylated compound comprising 2 (meth)acrylate groups and a hydroxyl-functional poly(meth)acrylated compound comprising 3 (meth)acrylate groups is used to prepare a urethane (meth)acrylate carrying 5 (meth)acrylate groups in case A(OH)ₓ is a diol.

With respect to the use of methacrylates or acrylates it should be considered whether the final urethane (meth)acrylates are to be employed in a thermally curable or UV curable coating composition; acrylates groups are preferred for UV curing and methacrylate groups are preferred for thermal curing.

According to the second alternative, in step (a2) the hydroxyl-functional poly(meth)acrylated compound according to formula (III) or a mixture of hydroxyl-functional poly(meth)acrylated compounds (III) is first reacted with the diisocyanate OCN-E-NCO in the presence of a polymerization inhibitor to form an isocyanate-functional poly(meth)acrylated product according to formula (IV)

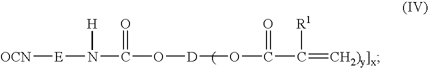

or a mixture of said isocyanate-functional poly(meth)acrylated products (IV) and then in step (b2) the isocyanate-functional poly(meth)acrylated product (VI) of step (a2) or the mixture of said isocyanate-functional poly(meth)acrylated compounds (IV) is reacted with the polymeric polyol A(OH)ₓ in the presence of a catalyst for urethane formation and a polymerization inhibitor to form the urethane (meth)acrylate according to formula (III). Similar to the first alternative, a mixture of hydroxyl-functional poly(meth)acrylated compounds must be used in step (a2) if a urethane (meth)acrylate (I) wherein y is not an integral multiple of x should be obtained.

A suitable catalyst is any catalyst known to effectively catalyze the urethane formation. Examples include tertiary amines, such as trimethylamine, diethylmethylamine, ethyldimethylamine, triethylamine, triethylenediamine, 2-methyltriethylenediamine, 1,4-diazobicyclo(2.2.2)octane, 2,6,7-trimethyl-1,4-diazobicyclo(2.2.2)octane, N,N′,N″-tris(dimethylaminoalkyl)hexahydrotriazine, and 2,4,6-tris(dimethylaminomethyl)phenol; and carboxylic acid salts, such as dibutyltin dilaurate, n-butyltin laurate, dibutyltin diacetate, stannous octoate (=tin 2-ethylhexanoate), copper naphthenate, cobalt naphthenate, zinc naphthenate, potassium acetate, and lead 2-ethylhexanoate. The catalyst may also be a mixture of at least two compounds. In some cases, the catalyst is used in an amount of from 0.1 to 2% by weight, based on the total weight of the corresponding reaction educts.

The polymerization inhibitor is added to avoid premature polymerization of the (meth)acrylate groups. Suitable inhibitors include, but are not limited to phenothiazine, hydroquinone, hydroquinone monomethyl ether, p-methoxyphenol, p-benzoquinone, t-butyl hydroquinone, triphenyl stybine, and o-nitrotoluene. The polymerization inhibitor may also be a mixture of at least two compounds. The polymerization inhibitor is preferably used within a range of from 50 to 5,000 ppm by weight, based on the total weight of the corresponding reaction educts.

In step (a1) of the first alternative the polymeric polyol A(OH)ₓ is reacted with the diisocyanate OCN-E-NCO in a ratio such that the molar ratio of the hydroxyl groups of the polymeric polyol A(OH)ₓ to the isocyanate groups of the diisocyanate OCN-E-NCO is about 1:2. For example 1 mole of a polymeric diol A(OH)₂ is reacted with 2 moles of the diisocyanate OCN-E-NCO.

The order of adding of the reaction components of step (a1) is not critical, however, in a preferred embodiment the polymeric polyol A(OH)ₓ is first added to an appropriate reaction vessel, e.g. a glass reactor, and then the diisocyanate OCN-E-NCO is added. Typically, the amount of isocyanate groups is monitored during the reaction, or at least after the total amount of diisocyanate OCN-E-NCO has been added. Generally, the reaction of step (a1) is considered complete when about 50% of the available isocyanate groups have been reacted.

In some cases, step (a1) is conducted at a temperature within the range of from 30 to 75° C., such as from 30 to 65° C., or, in some cases, about 50° C.

Typically, step (a1) is conducted under agitation, such as stirring.

If desired, a catalyst for urethane formation may be added to accelerate the reaction. A suitable catalyst is any catalyst known to effectively catalyze the urethane formation as described above.

In step (b1) of the first alternative the isocyanate-functional product (II) is often reacted with the hydroxyl-functional poly(meth)acrylated compound (III) in an equivalent ratio of about 1:1 meaning that the molar ratio of the isocyanate groups of the isocyanate-functional product (II) to the hydroxyl groups of the hydroxyl-functional poly(meth)acrylated compound (III) is about 1:1. For example 1 mole of an isocyanate-functional product (II) wherein x=2 is often reacted with 2 moles of the hydroxyl-functional poly(meth)acrylated compound (III).

The order of adding of the reaction components of step (b1) is not critical, However, in some embodiments, the isocyanate-functional product (II) remains in the reaction vessel used in step (a1) and then hydroxyl-functional poly(meth)acrylated compound (III) which has been mixed with the catalyst and the inhibitor in a previous step is added. Typically, the amount of isocyanate groups is monitored during the reaction, or at least after the total amount of hydroxyl-functional poly(meth)acrylated compound (III) has been added. Generally, the reaction of step (b1) is considered complete when the residual amount of isocyanate groups is less than 0.001 meq./g of the reaction mixture.

In some cases, step (b1) is conducted at a temperature within the range of from 50 to 85° C., such as from 50 to 75° C., or, in some cases, about 70° C.

Typically, step (b1) is conducted under agitation, such as stirring.

In step (a2) of the second alternative the hydroxyl-functional poly(meth)acrylated compound (IIIl) is often reacted with the diisocyanate OCN-E-NCO in a molar ratio of about 1:1.

The order of adding of the reaction components of step (a2) is not critical, However, in some embodiments, the hydroxyl-functional poly(meth)acrylated compound (III) is first added to an appropriate reaction vessel, e.g. a glass reactor, and mixed with the inhibitor. Then the diisocyanate OCN-E-NCO is added. Typically, the amount of isocyanate groups is monitored during the reaction, or at least after the total amount of diisocyanate OCN-E-NCO has been added. Generally, the reaction of step (a2) is considered complete when about 50% of the available isocyanate groups have been reacted.

Typically, step (a2) is conducted at a temperature within the range of from 30 to 70° C., such as 35 to 60° C., or, in some cases, from 40 to 50° C., such as about 45° C.

Typically, step (a2) is conducted under agitation, such as stirring.

If desired, a catalyst for urethane formation may be added to accelerate the reaction. A suitable catalyst is any catalyst known to effectively catalyze the urethane formation as described above.

In step (b2) of the second alternative the isocyanate-functional poly(meth)acrylated product (IV) is often reacted with the polymeric polyol A(OH)ₓ in an equivalent ratio of about 1:1 meaning that the molar ratio of the isocyanate groups of the isocyanate-functional poly(meth)acrylated product (IV) to the hydroxyl groups of the polymeric polyol A(OH)ₓ is about 1:1. For example, 2 moles of the isocyanate-functional poly(meth)acrylated product (IV) are often reacted with 1 mole of a polymeric polyol A(OH)ₓ wherein x=2.

The order of adding of the reaction components of step (b2) is not critical, However, in some embodiments, the isocyanate-functional poly(meth)acrylated product (IV) remains in the reaction vessel used in step (b2) and then polymeric polyol A(OH)ₓ which has been mixed with the catalyst in a previous step is added. Typically, the amount of isocyanate groups is monitored during the reaction, or at least after the total amount of polymeric polyol A(OH)ₓ has been added. Generally, the reaction of step (b2) is considered complete when the residual amount of isocyanate groups is less than 0.001 meq./g of the reaction mixture.

Often, step (b2) is conducted at a temperature within the range of from 45 to 90° C., such as from 50 to 80° C., in some cases, from 60 to 75° C., or, in yet other cases, about 70° C.

Typically, step (b2) is conducted under agitation, such as stirring.

In a preferred embodiment all reaction steps according to both alternatives are carried out in the absence of any solvent.

It is sometimes preferred to prepare the new urethane (meth)acrylates according to the first method.

If desired, the urethane (meth)acrylates obtained according to any of the above methods may be diluted with a solvent and/or a reactive diluent to adjust the viscosity.

Examples of solvents include butyl acetate, isopropyl alcohol, and propylene glycol methyl ether (commercially available as Dowanol® PM from The Dow Chemical Company, U.S.A.). Mixtures of solvents may also be used.

Suitable reactive diluents are e.g. multi-functional (meth)acrylates. Examples of reactive diluents include diethylene glycol di(meth)acrylate, ethoxylated bisphenol A di(meth)acrylate, 1,6-hexanediol di(meth)acrylate, neopentyl glycol di(meth)acrylate, polyethylene glycol di(meth)acrylate, preferably having a number average molecular weight of from 200 to 400, propoxylated neopentyl glycol di(meth)acrylate, tetraethylene glycol di(meth)acrylate, triethylene glycol di(meth)acrylate, tripropylene glycol di(meth)acrylate, trimethylolpropane tri(meth)acrylate, ethoxylated trimethylolpropane tri(meth)acrylate, tris (2-hydroxyethyl)isocyanurate tri(meth)acrylate, propoxylated glycerol tri(meth)acrylate, pentaerythritol tri (meth)acrylate, propoxylated pentaerythritol tri(meth)acrylate, pentaerythritol tetra(meth)acrylate, and dipentaerythritol penta- and hexa(meth)acrylate. Mixtures of reactive diluents may also be used. The preferred reactive diluents are 1,6-hexane diol di(meth)acrylate and trimethylolpropane tri(meth)acrylate.

In order to improve the shelf life of the urethane (meth)acrylates it is sometimes advantageous to add further additives, such as stabilizers and/or antioxidants. The stabilizers may be selected from the polymerization inhibitors mentioned above. Preferred stabilizer are hydroquinone and the methyl ether of hydroquinone. Examples of antioxidants include trisnonylphenyl phosphite (TNPP).

The urethane (meth)acrylate according to the present invention may be used as a component in a coating composition, optionally in combination with a low molecular weight hexafunctional urethane (meth)acrylate known from the prior art. The coating composition may be cured thermally, by UV radiation or by electron beam. Preferably, the urethane (meth)acrylates are used in UV curable coating compositions.

The thermally curable coating compositions often comprise a heat curing catalyst, such as a conventionally used peroxide initiator, and optionally an accelerator. Examples of peroxide initiators include diacyl peroxide compounds such as benzoyl peroxide, peroxy ester compounds, hydroperoxide compounds, dialkyl peroxide compounds, ketone peroxide compounds, peroxy ketal compounds, alkyl perester compounds, and percarbonate compounds. Mixtures of different peroxide initiators may also be used. The amount of peroxide initiator(s) is typically 0.1 to 3% by weight and preferably 0.5 to 1.5 by weight, each based on the total solids weight of the coating composition.

The accelerator increases the cure speed of the coating composition; it may be added immediately before application of the coating composition as it may shorten the potlife. Examples of accelerators include cobalt salts, such as cobalt naphthenate; zinc naphthenate; and manganese naphthenate. Mixtures of different accelerators may also be used. The amount of accelerator(s) is typically 0.5 to 6% by weight and preferably 2 to 3% by weight, each based on the total solids weight of the coating composition.

The UV curable coating compositions also often comprise a photoinitiator. Examples of photoinitiators include benzoin alkyl ether and other benzoin ether compounds; benzophenone, benzyl o-benzoyl benzoate, methyl o-benzoyl benzoate, and other benzophenone compounds; benzyl dimethyl ketal, 2,2-diethoxyacetophenone, 2-hydroxy-2-methylpropiophenone, 4′-isopropyl-2-hydroxy-2-methylpropiophenone, 1,1-dichloroacetophenone, and other acetophenone compounds; 2-chlorothioxanthone, 2-methylthioxanthone, 2-isopropylthioxanthone, and other thioxanthone compounds; and other ketone compounds. Mixtures of different photoinitiators may also be used. The amount of photoinitiator(s) is typically from 5 to 10% by weight and preferably 6 to 8% by weight, each based on the total solids weight of the coating composition.

The UV curable coating compositions may, for example, be cured by irradiating with a mercury medium-pressure lamp. Curing is typically done at room temperature; however it may be required to flash off any solvents, if used, in order to adjust the viscosity.

There is no need of a curing catalyst in electron beam curable coating compositions, however, an electron beam curing catalyst may be added, if desired.

The low molecular weight hexafunctional urethane (meth)acrylates which may be used as optional co-binders include aromatic and aliphatic low molecular weight hexafunctional urethane (meth)acrylates, typically the reaction products of pentaerythritol tri(meth)acrylate and toluene diisocyanate or isophorone diisocyanate. Mixtures of various low molecular weight hexafunctional urethane (meth)acrylates may also be used. A suitable co-binder is the reaction product of pentaerythritol triacrylate and toluene diisocyanate, e.g. commercially available as Ultra Beam U-650 from PPG Industries (Singapore) Pte Ltd.

Additional optional components of the coating compositions according to the present invention include, but are not limited to stabilizers, light stabilizers, reactive diluents that may be required to adjust the viscosity and solvents that may also be required to adjust the viscosity, but usually must be driven off prior to the actual curing process. Further common additives, such as matting agents and leveling agents, may also be included.

The stabilizers may be selected from the polymerization inhibitors mentioned above. Preferred stabilizer are hydroquinone and the methyl ether of hydroquinone. If used stabilizer(s) are typically included in an amount of from 100 to 1,000 ppm by weight, preferably from 100 to 500 ppm by weight, each based on the total solids weight of the coating composition.

The term “light stabilizer” includes UV absorbers and UV light stabilizers. Examples of UV absorbers and UV light stabilizers include, but are not limited to substituted benzophenone, substituted benzotriazoles, hindered amines, and hindered benzoates, such as diethyl-3-acetyl-4-hydroxy-benzyl-phosphonate, 4-dodecyloxy-2-hydroxy benzophenone, and resorcinol monobenzoate. If used light stabilizer(s) are typically included in an amount of at least 0.15% by weight, preferably at least 0.30% by weight, each based on the total solids weight of the coating composition.

Examples of reactive diluents include those mentioned above. Mixtures of reactive diluents may also be used. If used reactive diluent(s) are typically included in an amount of up to 60% by weight, based on the total weight of the coating composition.

Examples of solvents include those mentioned above. Mixtures of solvents may also be used. If used solvent(s) are typically included in an amount of up to 50% by weight, such as up to 20% by weight, each based on the total weight of the coating composition. In some cases, the coating compositions according to the present invention are solvent-free. With respect to environmental concerns, the absence of solvent is especially favorable.

Often, the coating composition comprises 30 to 60% by weight of the urethane (meth)acrylate(s) according to the present invention, such as 40 to 50% by weight, based on the total solids weight of the coating composition. It is understood that mixtures of various different urethane (meth)acrylates may also be used. If a low molecular weight hexafunctional urethane (meth)acrylate or a mixture of various low molecular weight hexafunctional urethane (meth)acrylates is used as a co-binder, the coating composition often comprises 30 to 50% by weight, such as 30 to 45% by weight of the urethane (meth)acrylates according to the present invention and 2 to 30% by weight, such as 5 to 15% by weight of the low molecular weight hexafunctional urethane (meth)acrylate(s), each based on the total solids weight of the coating composition.

The coating compositions according to the present invention may be applied to various types of substrates, such as wood, plastic (e.g. acrylonitrile-butadiene-styrene-copolymers, polyolefins, polyesters, PVC), concrete, masonry, paper, and metallic substrates.

The coating composition according to the present invention may be applied by conventional coating equipment, e.g. a roller coater, spray coater, curtain coater, and flow coater. Depending on the intended use it may also be applied to only selected parts of the substrate by conventional printing techniques, e.g. screen printing, offset printing, and flexo printing.

The coating compositions according to the present invention may be cured within a short time, often within 3 seconds, often within 2 seconds. The cured coating compositions exhibit high hardness, as well as superior scratch, abrasion, and chemical resistance. Their stain resistance and toughness (flexibility) is also outstanding. Coating compositions comprising urethane (meth)acrylates derived from aliphatic isocyanates further show no yellowing.

Exemplary applications of the coating compositions according to the present invention include the manufacturing of parquet flooring, kitchen cabinets, table tops, polyester films, and printed circuit boards.

The present invention is further illustrated by the following examples:

### EXAMPLE 1 (Aromatic Urethane Acrylate)

1025 g of Arcol 1010 from Bayer MaterialScience AG (a polyoxypropylene glycol having a M_{W} of about 1000) were loaded into a dry glass reactor with agitation and under a N₂ sparge. The mixture was heated to 50° C. 357 g of TDI (80/20 mixture of 2,4- and 2,6-toluene diisocyanate) were added slowly under mixing over a period of 1 h. An exotherm was generated and the temperature was controlled such that it did not exceed 70° C.

Once all the TDI was added, samples for NCO determination were taken every 20 min. Once 50% of the available isocyanate groups were reacted, meaning remaining NCO value of 1.49 meq NCO/g, 651 g of pentaerythritol triacrylate (which was previously blended with 1 g of hydroquinone and 3 g of stannous octoate) were gradually added to the mixture. An exotherm was generated and the reaction was controlled up to 70° C. to prevent preliminary polymerization or gelation.

Once all the pentaerythritol triacrylate was added, samples to determine residual NCO levels need to be taken. The reaction is considered as being terminated if the residual NCO content is less than 0.001 meq/g.

Under agitation, an additional 0.4 g of hydroquinone and 0.4 g of trisnonylphenyl phosphite were added as post stabilizers and antioxidants. The resin was further diluted with 200 g of 1,6-hexane diol diacrylate and 400 g of trimethylolpropane triacrylate.

### EXAMPLE 2 (Aliphatic Urethane Acrylate)

1025 g of Arcol 1010 from Bayer MaterialScience AG (a polyoxypropylene glycol having a M_{W} of about 1000) were loaded into a dry glass reactor with agitation and under a N₂ sparge. The mixture was heated to 50° C. 446 g of IPDI (isophorone diisocyanate) were added slowly under mixing over a period of 1 h. An exotherm was generated and the temperature was controlled such that it did not exceed 70° C.

Once all the IPDI was added, samples for NCO determination were taken every 20 min. Once 50% of the available isocyanate groups were reacted, meaning remaining NCO value of 1.49 meq NCO/g, 651 g of pentaerythritol triacrylate (which was previously blended with 1.12 g of hydroquinone and 3.2 g of stannous octoate) were gradually added to the mixture. An exotherm was generated and the reaction was controlled up to 70° C. to prevent preliminary polymerization or gelation.

Once all the pentaerythritol triacrylate was added, samples to determine residual NCO levels need to be taken. The reaction is considered as being terminated if the residual NCO content is less than 0.001 meq/g.

Under agitation, an additional 0.42 g of hydroquinone and 0.42 g of trisnonylphenyl phosphite were added as post stabilizers and antioxidants. The resin was further diluted with 200 g of 1,6-hexane diol diacrylate and 400 g of trimethylolpropane triacrylate.

### EXAMPLE 3 (Aromatic Urethane Acrylate)

916.9 g of pentaerythritol triacrylate were loaded into a dry glass reactor with agitation and under a N₂ sparge. 1 g of hydroquinone which was used as a stabilizer was added during 30 min under agitation. Once all the hydroquinone has been dissolved addition of 348 g of TDI (80/20 mixture of 2,4- and 2,6-toluene diisocyanate) over a period of 2 h was started. An exotherm occurred and the temperature of the mass was controlled such the temperature did not exceed 45° C. After the addition was terminated the disappearance of the residual NCO groups was controlled. Once the NCO levels reached 2.12 meq NCO/g, the addition of 1025 g of Arcol 1010 from Bayer MaterialScience AG (a polyoxypropylene glycol having a M_{W} of about 1000) over a period of 3 h was started. The polyoxypropylene glycol had previously been blended with 3 g of stannous octoate which serves as a catalyst. The reaction of the second step started and the reaction temperature was controlled by heating or cooling such that it did not exceed 70° C. to prevent preliminary gelation of the mass.

Once all the polyoxypropylene glycol was added, samples to determine residual NCO levels need to be taken. The reaction is considered as being terminated if the residual NCO content is less than 0.001 meq/g.

Under agitation, an additional 0.4 g of hydroquinone and 0.4 g of trisnonylphenyl phosphite were added as post stabilizers and antioxidants. The resin was further diluted with 200 g of trimethylolpropane triacrylate.

### EXAMPLE 4 (Aliphatic Urethane Acrylate)

916.9 g of pentaerythritol triacrylate were loaded into a dry glass reactor with agitation and under a N₂ sparge. 1 g of hydroquinone which is used as a stabilizer is added during 30 minutes under agitation. Once all the hydroquinone has been dissolved the addition of 446 g of IPDI (isophorone diisocyanate) over a period of 2 h was started. An exotherm occurred and the temperature of the mass was controlled such the temperature did not exceed 45° C. After the addition was terminated the disappearance of the residual NCO groups was controlled. Once the NCO levels reached 1.92 meq NCO/g, the addition of 1025 g of Arcol 1010 from Bayer MaterialScience AG (a polyoxypropylene glycol having a M_{W} of about 1000) over a period 3 h was started. The polyoxypropylene glycol had previously been blended with 3 g of stannous octoate which serves as a catalyst. The reaction of the second step started and the reaction temperature was controlled by heating or cooling such that it did not exceed 70° C. to prevent preliminary gelation of the mass.

Once all the polyoxypropylene glycol was added, samples to determine residual NCO levels need to be taken. The reaction is considered as being terminated if the residual NCO content is less than 0.001 meq/g.

Under agitation, an additional 0.4 g of hydroquinone and 0.4 g of trisnonylphenyl phosphite were added as post stabilizers and antioxidants. The resin was further diluted with 200 g of trimethylolpropane triacrylate.

### EXAMPLES 5 TO 9 (Coating Compositions)

The coating compositions were prepared by mixing the components reported in Table 1.

TABLE 1
Coating Compositions

| | | Ex. 6 | | Ex. 8 | Ex. 9 |
|---|---|---|---|---|---|
| | Ex . 5 | (comp.) | Ex. 7 | (comp.) | (comp.) |
| Components | parts by weight | | | | |
| UA-EX-1 | 32 | | | | |
| UA-EX-2 | | | 32 | | |
| UA-TDI | 10 | 42 | 10 | 10 | 10 |
| UA-IPDI | | | | 32 | |
| DPHA | | | | | 32 |
| TMPTA | 32 | 32 | 32 | 32 | 32 |
| HDDA | 8 | 8 | 8 | 8 | 8 |
| Acematt TS 100 | 8 | 8 | 8 | 8 | 8 |
| Darocure 1173 | 3 | 3 | 3 | 3 | 3 |
| Irgacure 819 | 1 | 1 | 1 | 1 | 1 |
| Irgacure 184 | 2 | 2 | 2 | 2 | 2 |
| Benzophenone | 3 | 3 | 3 | 3 | 3 |
| Lancowax TF 1778 | 1 | 1 | 1 | 1 | 1 |
| | 100 | 100 | 100 | 100 | 100 |

| | |
|---|---|
| comp. | comparative example |
| UA-EX-1 | Aromatic hexafunctional urethane acrylate |
| | prepared according to Example 1 (parts by weight |
| | do not include the 1,6-hexane diol diacrylate |
| | and trimethylolpropane triacrylate added |
| | in Ex. 1) |
| UA-EX-2 | Aliphatic hexafunctional urethane acrylate |
| | prepared according to Example 2 (parts by weight |
| | do not include the 1,6-hexane diol diacrylate |
| | and trimethylolpropane triacrylate added |
| | in Ex. 2) |
| UA-TDI | Commercial low molecular weight aromatic |
| | hexafunctional urethane acrylate, reaction product |
| | of pentaerythritol triacrylate and TDI (Ultra Beam |
| | U-650, supplied by PPG Industries |
| | (Singapore) Pte Ltd.) |
| UA-IPDI | Low molecular weight aliphatic hexafunctional |
| | urethane acrylate, reaction product of pentaerythritol |
| | triacrylate and IPDI |
| DPHA | Dipentaerythritol hexaacrylate |
| TMPTA | Trimethylolpropane triacrylate |
| HDDA | 1,6-Hexane diol diacrylate |
| Acematt TS 100 | Matting agent, fumed silica, supplied |
| | by Degussa AG, Germany |
| Darocure 1173 | Photoinitiator (2-hydroxy-2-methyl-1- |
| | phenyl-1-propanone), supplied by Ciba |
| | Specialty Chemicals, Switzerland |
| Irgacure 184 | Photoinitiator (1-benzoyl-1-hydroxycyclohexane), |
| | Supplied by Ciba Specialty Chemicals |
| Benzophenone | Photoinitiator, supplied by Ciba Specialty |
| | Chemicals |
| Irgacure 819 | Photoinitiator (bis(2,4,6-trimethylbenzoyl) |
| | phenylphosphine oxide), supplied by Ciba |
| | Specialty Chemicals |
| Lancowax TF 1778 | Leveling agent, supplied by Lanco Glidd |

### Coating Application and Curing

The coating compositions of examples 5 to 9 are applied as top coats to a wooden substrate (Kampas wood). Altogether, six layers of coatings are applied by means of a differential roller coater and cured by medium-pressure mercury lamps. A sanding step is performed after the application of the second layer of the UV sealer.

TABLE 2
Coating Layers

| Type of coating | Coat weight | UV cure speed | Radiation source |
|---|---|---|---|
| UV primer | 10 g/m² | 10 m/min | 1 lamp 80 W/cm |
| UV filler | 15 g/m² | 10 m/min | 1 lamp 80 W/cm |
| UV sealer, layer 1 | 15 g/m² | 10 m/min | 1 lamp 80 W/cm |
| UV sealer, layer 2 | 15 g/m² | 10 m/min | 1 lamp 80 W/cm |
| top coat, layer 1 | 10 g/m² | 10 m/min | applied wet-on-wet, |
| (Ex. 5 to 9) | | | 2 lamps 80 W/cm |
| top coat, layer 1 | 10 g/m² | 10 m/min | |
| (Ex. 5 to 9) | | | |

UV primer is Crown UV Primer; UV filler is Crown UV PU Acrylic Sealer SR Filler; and UV Sealer is Crown UV PU Acrylic Sealer SR UV Sealer, all supplied by PPG Industries (Singapore) Pte Ltd.

TABLE 3
Coating Properties

| | | Ex. 6 | | Ex. 8 | Ex. 9 |
|---|---|---|---|---|---|
| | Ex. 5 | (comp.) | Ex. 7 | (comp.) | (comp.) |
| Pencil | 3H | 3H | 3H | 3H | 3H |
| harness | | | | | |
| Solvent | >50 rubs | >50 rubs | >50 rubs | >50 rubs | >50 rubs |
| resistance | | | | | |
| (acetone | | | | | |
| rubs) | | | | | |
| Steel wool | pass | pass | fail | fail | fail |
| scratch | | | | | |
| resistance (a) | | | | | |
| Coin scrape | (1) | (1) | (2) | (2) | (2) |
| test (b) | | | | | |
| Flexibility | flexible | brittle | flexible | brittle | brittle |

(a) 20 Rubs of steel wool are rubbed over the surface showing (non) visual scratches.
(b) A metallic coin was scraped over the surface, showing (1) slight marks or showing (2) visible white scratches.

Only the coating compositions according to the present invention (Ex. 5 and 7) result in coatings that exhibit hardness and solvent resistance in combination with flexibility. Although Ex. 7 did not pass the steel wool scratch and coin scrape test the coating is still hard enough (pencil hardness 3H) for various applications and/or if used on harder substrates.

1. A urethane (meth)acrylate represented by the general formula (I) 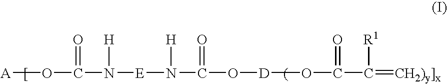
wherein
A is the residue of a polyhydric polymeric alcohol A(OH)ₓ being selected from polyether polyols, polyester polyols, polyacrylic polyols, polycaprolactone polyols, polycarbonate polyols, polyurethane polyols, and polyamide polyols;
x is 2, 3 or 4;
E is the residue of a diisocyanate OCN-E-NCO;
D is the residue of a polyhydric monomeric alcohol D(OH)_{y+1};
y is 2 to 5;
R¹ is H or methyl;
E, D, R¹, y, and x are identical or different within each molecule of the urethane (meth)acrylate;
and x and y are selected that the total number of (meth)acrylate groups —O—CO—CR¹═CH₂ is from 5 to 15.

2. The urethane (meth)acrylate according to claim 1 wherein the total number of (meth)acrylate groups is from 5 to 9.

3. The urethane (meth)acrylate according to claim 1 wherein y is 2 or 3.

4. The urethane (meth)acrylate according to claim 1 wherein the polymeric alcohol A(OH)ₓ is a polyether polyol.

5. The urethane (meth)acrylate according to claim 1 wherein x is 2.

6. The urethane (meth)acrylate according to claim 1 wherein the monomeric alcohol D(OH)_{y+1} is pentaerythritol.

7. The urethane (meth)acrylate according to claim 1 wherein the diisocyanate OCN-E-NCO is toluene diisocyanate or isophorone diisocyanate.

8. A method for preparing a urethane (meth)acrylate according to claim 1 comprising the following steps:
(a1) reacting a polyhydric polymeric alcohol A(OH)ₓ being selected from polyether polyols, polyester polyols, polyacrylic polyols, polycaprolactone polyols, polycarbonate polyols, polyurethane polyols, and polyamide polyols; with a diisocyanate OCN-E-NCO or a mixture of diisocyanates OCN-E-NCO to form an isocyanate-functional product according to formula (II) 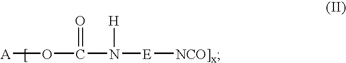
and
(b1) reacting the isocyanate-functional product (II) of step (a1) with a hydroxyl-functional poly(meth)acrylated compound according to formula (III) 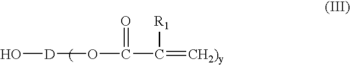
or a mixture of said hydroxyl-functional poly(meth)acrylated compounds (III) in the presence of a catalyst for urethane formation and a polymerization inhibitor to form the urethane (meth)acrylate according to formula (III),
wherein A, E, D, R¹, y, and x are defined as in claim 1.

9. A method for preparing a urethane (meth)acrylate according to claim 1 comprising the following steps:
(a2) reacting a hydroxyl-functional poly(meth)acrylated compound according to formula (III) 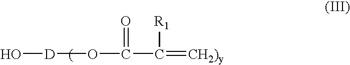
or a mixture of hydroxyl-functional poly(meth)acrylated compounds (III) with a diisocyanate OCN-E-NCO in the presence of a polymerization inhibitor to form an isocyanate-functional poly(meth)acrylated product according to formula (IV) 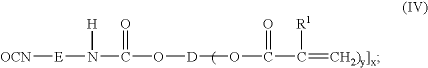
or a mixture of said isocyanate-functional poly(meth)acrylated products (IV) and
(b2) reacting the isocyanate-functional poly(meth)acrylated product (IV) of step (a2) or the mixture of said isocyanate-functional poly(meth)acrylated products (IV) with a polyhydric polymeric alcohol A(OH)ₓ being selected from polyether polyols, polyester polyols, polyacrylic polyols, polycaprolactone polyols, polycarbonate polyols, polyurethane polyols, and polyamide polyols, in the presence of a catalyst for urethane formation and a polymerization inhibitor to form the urethane (meth)acrylate according to formula (III),
wherein A, E, D, R¹, y, and x are defined as in claim 1.

10. A curable coating composition comprising the urethane (meth)acrylate according to claim 1.

11. The curable coating composition according to claim 10 further comprising a member selected from the group consisting of a heat curing catalyst, a photoinitiator and an electron beam catalyst.

12. The curable coating composition according to claim 10 further comprising a reactive diluent.

13. The curable coating composition according to claim 10 further comprising a low molecular weight hexafunctional urethane (meth)acrylate.

14. A cured coating obtainable by curing the coating composition according to claim 10.
